(19) United States
(12) Patent Application Publication
(10) Pub. No.: US 2025/0050562 A1
(43) Pub. Date: Feb. 13, 2025

(54) INJECTION MODLING METHODS, TOOLING, AND PRODUCTS

(71) Applicant: Gavco Plastics, Inc., Broken Arrow, OK (US)

(72) Inventors: Dean Michael Sellers, Broken Arrow, OK (US); Wesley A. York, Tulsa, OK (US)

(21) Appl. No.: 18/797,831

(22) Filed: Aug. 8, 2024

Related U.S. Application Data
(60) Provisional application No. 63/531,503, filed on Aug. 8, 2023.

(51) Int. Cl. B29C 45/26; B29C 45/14; B29C 45/17; B29C 45/18; B29C 45/34; B29C 45/76; B29C 45/77; B29K 105/00

(52) U.S. Cl. CPC B29C 45/2628; B29C 45/14065; B29C 45/176; B29C 45/18; B29C 45/34; B29C 45/7613; B29C 45/77; B29C 2045/14131; B29C 2945/76063; B29C 2945/76083; B29C 2945/76267; B29C 2945/76287; B29C 2945/76545; B29K 2105/0094

(57) ABSTRACT

The present disclosure pertains to injection molding methods, tooling, and products. An example injection molding tool that can be used to create both a part with an aperture and a part without an aperture. The injection molding tool has a first portion; a second portion; a first insert installed on the first portion, the insert comprising a protrusion that creates a gap relative to a sidewall of the second portion when the first portion and the second portion are closed to form an injection molding tool; and a material source that flows material into the injection molding tool, the material having a melt flow rate that is below a melt flow rate threshold to create a first part with an aperture due to the presence of the protrusion and the gap, wherein the aperture has no flashing.

### CROSS REFERENCE TO RELATED APPLICATIONS

This non-provisional application claims the benefit and priority of U.S. Provisional Application Ser. No. 63/531,503, filed on Aug. 8, 2023, which is hereby incorporated herein in its entirety including all references and appendices cited therein.

### FIELD

This disclosure pertains to the field of injection molding technology, specifically to molds with interchangeable inserts for producing parts with and without apertures, while maintaining high quality and preventing blemishes or flashing.

### SUMMARY

According to some embodiments, the present disclosure is directed to an injection molding tool that can be used to create both a part with an aperture and a part without an aperture. The injection molding tool also includes a first portion; a second portion; a first insert installed on the first portion, the insert may include a protrusion that creates a gap relative to a sidewall of the second portion when the first portion and the second portion are closed to form an injection molding tool; a material source that flows material into the injection molding tool, the material having a melt flow rate that is below a melt flow rate threshold to create a first part with an aperture due to the presence of the protrusion and the gap, where the aperture has no flashing.

Implementations may include one or more of the following features. The injection molding tool may include a second insert that can be installed in place of the first insert to produce a second part that is identical to the first part but having no aperture. The injection molding tool may include a vent aperture in the first insert and extending through the protrusion, for venting gas that accumulates between the sidewall of the second portion and the protrusion. The injection molding tool may include: a sensor configured to measure the melt flow rate of the material; and a controller that includes a processor and memory, the controller being configured to receive output from the sensor and shutoff the material source when the melt flow rate is above the melt flow rate threshold. The injection molding tool may include: an optical sensor that is configured to measure a location of the protrusion and a location of the sidewall of the second portion when the injection molding tool is open; and the controller being configured to infer a size of the gap based on output of the optical sensor. The injection molding tool may include a plurality of adjustable spacers positioned around an outer-periphery of the first part, the plurality of adjustable spacers are configured to be adjusted to maintain a size of the gap. Implementations of the described techniques may include hardware, a method or process, or computer software on a computer-accessible medium.

One general aspect includes a method for producing a part with an aperture and a part without an aperture with a single mold. The method also includes providing a mold having a first portion, a second portion, and a first insert that can be installed on the first portion, the insert may include a protrusion that does not create a shutoff relative to the second portion when the first portion and the second portion are closed to form the mold; and flowing a material into the mold, the material having a melt flow rate that is below a melt flow rate threshold to create a part with an aperture due to the presence of the protrusion, where the aperture has no flashing. Other embodiments of this aspect include corresponding computer systems, apparatus, and computer programs recorded on one or more computer storage devices, each configured to perform the actions of the methods.

Implementations may include one or more of the following features. The method may include: opening the mold; removing the first insert; inserting a second insert; and flowing a material into the mold to create a part without an aperture. The method may include venting through the first insert to prevent gas being trapped between the first insert and the second portion of the mold. The method may include: placing one or more spacers around an outer-periphery of either the first portion or the second portion; and adjusting the one or more spacers to maintain a size of the gap. Implementations of the described techniques may include hardware, a method or process, or computer software on a computer-accessible medium.

The injection molding tool also includes a first mold portion; a second mold portion; a first insert mounted on the first mold portion, the first insert having a protrusion that forms a gap with a sidewall of the second mold portion when the mold portions are closed; and a second insert replaceable with the first insert, the second insert lacking the protrusion. Other embodiments of this aspect include corresponding computer systems, apparatus, and computer programs recorded on one or more computer storage devices, each configured to perform the actions of the methods.

Implementations may include one or more of the following features. The injection molding tool may include a material source designed to inject material into the mold, where the material has a melt flow rate below a predefined threshold, resulting in the formation of a part with an aperture due to the presence of the protrusion and the gap, where the aperture is free of flashing. The injection molding tool may include a vent aperture in the first insert and extending through the protrusion, for venting gas that accumulates between the sidewall of the second portion and the protrusion. The injection molding tool may include: a sensor configured to measure the melt flow rate of the material; and a controller that includes a processor and memory, the controller being configured to receive output from the sensor and shutoff the material source when the melt flow rate is above the melt flow rate threshold. The injection molding tool may include: an optical sensor that is configured to measure a location of the protrusion and a location of the sidewall of the second portion when the injection molding tool is open; and the controller being configured to infer a size of the gap based on output of the optical sensor. The injection molding tool may include a plurality of adjustable spacers positioned around an outer-periphery of the first part, the plurality of adjustable spacers are configured to be adjusted to maintain a size of the gap.

### BRIEF DESCRIPTION OF THE DRAWINGS

FIG. 1 is a perspective view of an example core of a tool of the present disclosure.

FIG. 2 is a perspective view of an example cavity of a tool of the present disclosure.

FIGS. 3A and 3B collectively illustrate an example insert of the present disclosure.

FIG. 4A is a cross-sectional view of the core, cavity, and insert, such as the insert of

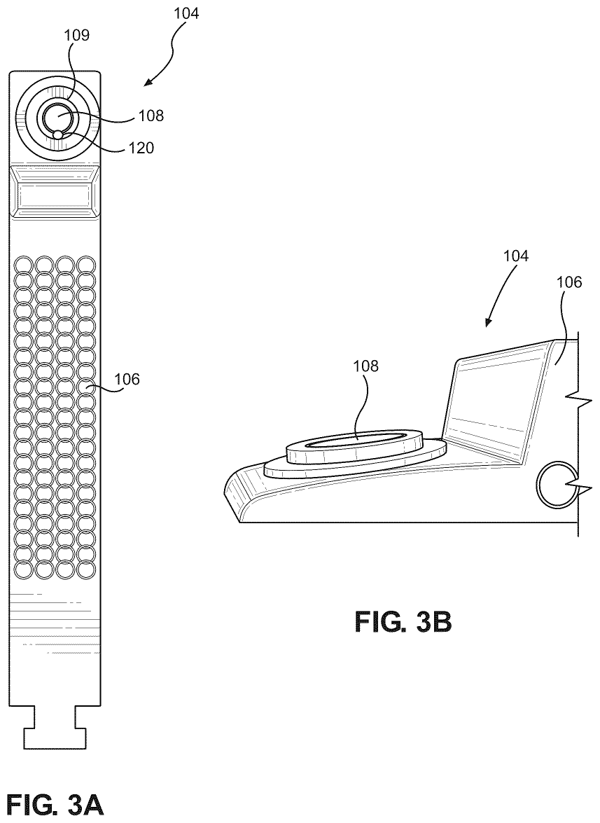

FIGS. 3A and 3B, that produces an aperture without flashing.

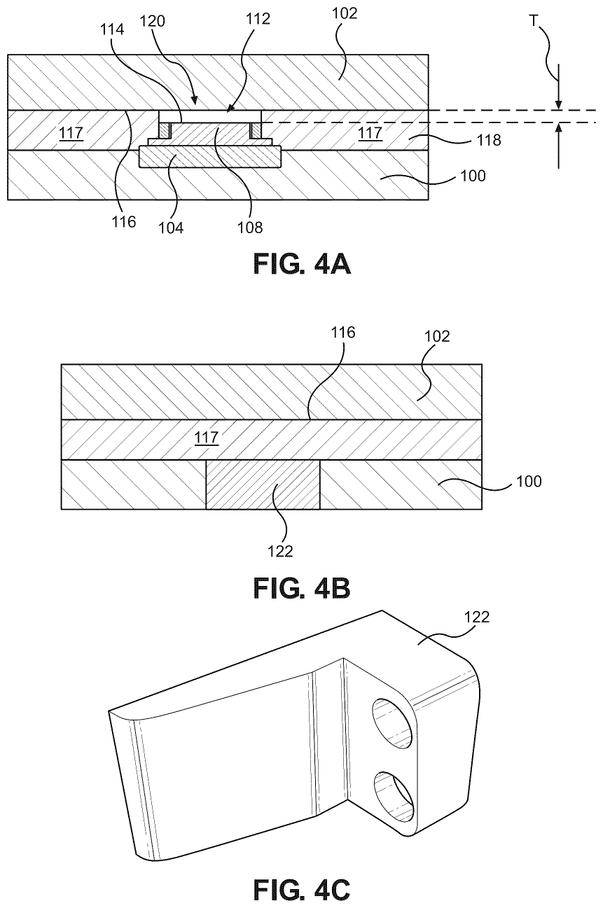

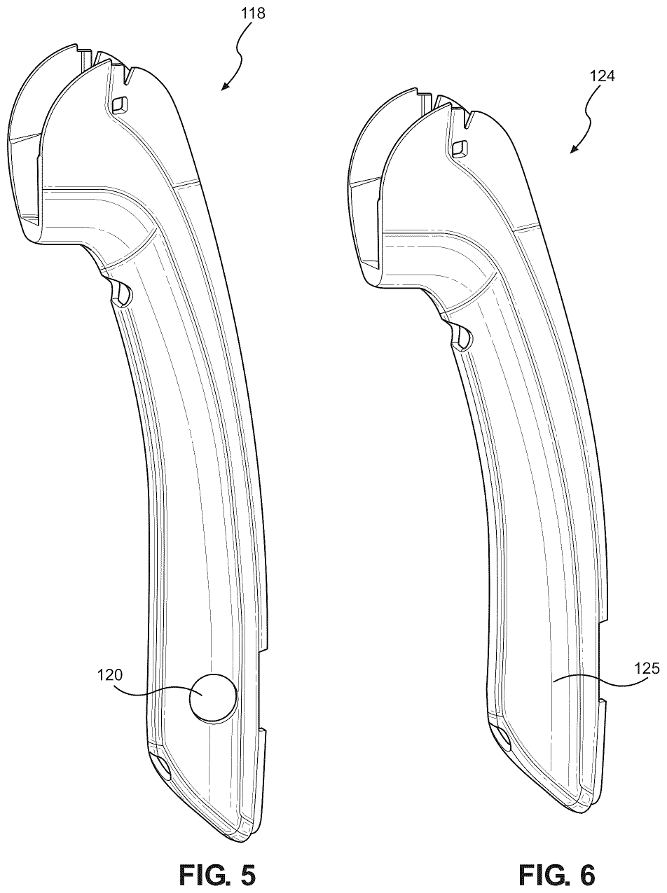

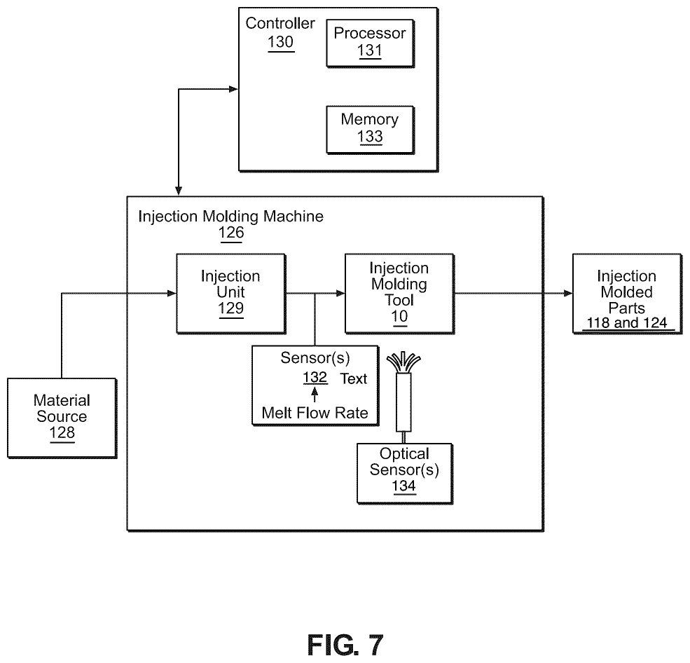

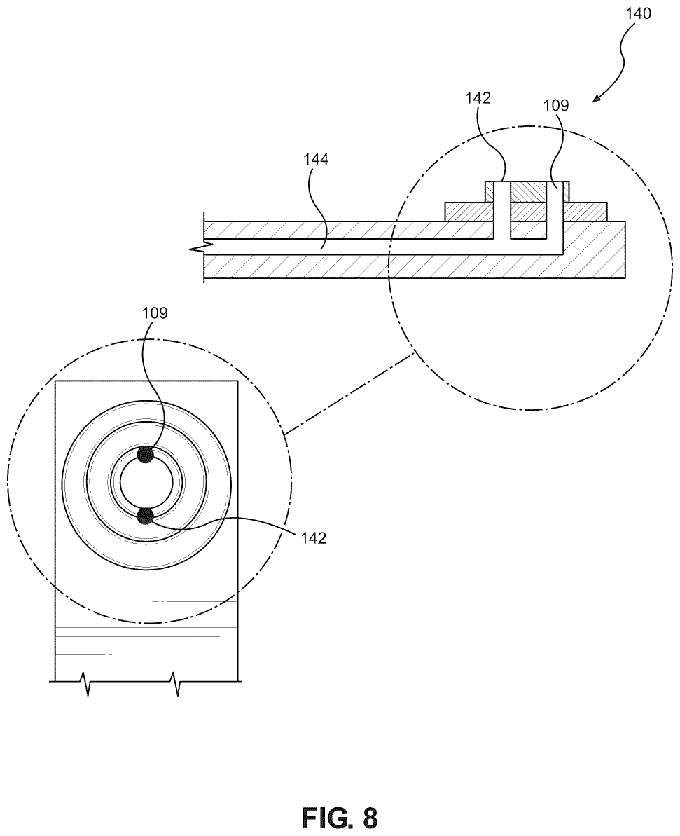

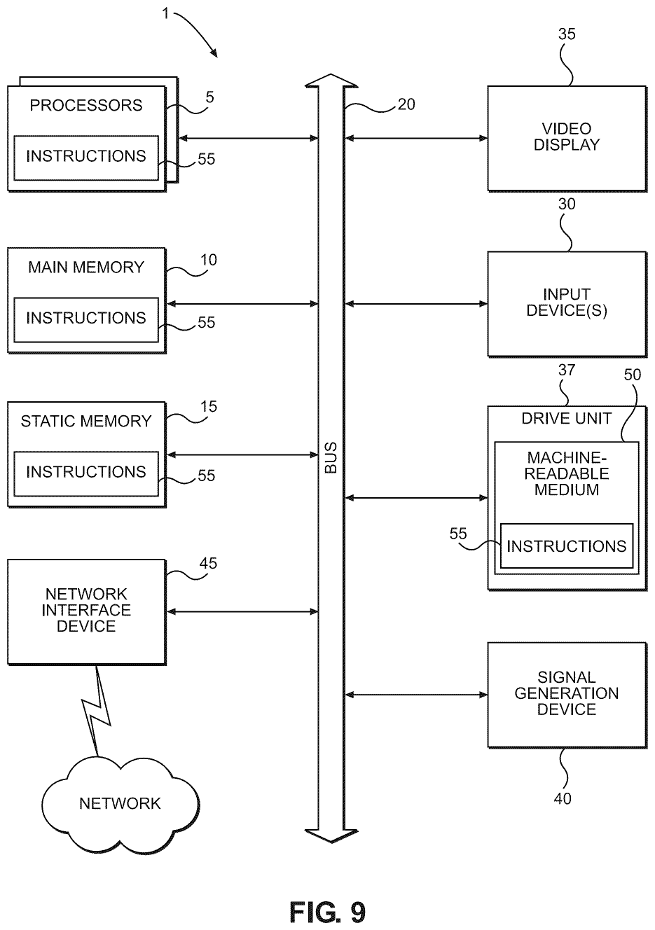

FIG. 4B is a cross section of the core, cavity, and an alternative insert.

FIG. 4C is a perspective view of the alternative insert of FIG. 4B.

FIG. 5 is a perspective view of a part with an aperture created using the insert of FIGS. 3A, 3B, and 4A.

FIG. 6 is a perspective view of a part without an aperture created using the insert of FIG. 4B.

FIG. 7 is a schematic diagram of an example system of the present disclosure.

FIG. 8 is a cross-sectional view of an example insert having an integrated optical sensor.

FIG. 9 is a schematic diagram of an example computer system that can be used in embodiments of the present disclosure.

### DETAILED DESCRIPTION OF EXAMPLE EMBODIMENTS

### Overview

In traditional injection molding, creating identical parts with and without apertures using the same mold often presents significant challenges. The main issue arises from the necessity of a shutoff, where the insert must touch the mold's sidewall to form an aperture. This contact point frequently results in blemishes, marks, or flashing on the molded parts, compromising their quality and aesthetic appearance.

A blemish in this context is typically a surface defect that manifests as unwanted marks or material overflow (flashing) around the aperture. These blemishes occur due to several factors inherent to the shutoff process. When the protrusion of the insert makes contact with the mold's sidewall to form a shutoff, any misalignment, wear, or imperfections in the mold surfaces can create uneven contact points. This uneven contact can cause the molten material to seep through tiny gaps between the protrusion and the sidewall, leading to flashing. The pressure exerted during the molding process can force the material into these gaps, resulting in excess material forming around the edges of the aperture.

Moreover, repeated cycles of the molding process can exacerbate these issues. The constant contact between the protrusion and the sidewall causes wear and tear on the mold surfaces. Over time, this wear can create small indents or deformities on the sidewall, making it even harder to achieve a perfect shutoff. These deformations become sites where material can accumulate, leading to persistent blemishes on subsequent parts.

Additionally, the thermal expansion and contraction of the mold components during the heating and cooling cycles can further affect the shutoff integrity. Variations in temperature can cause the mold and insert materials to expand or contract at different rates, altering the gap size and contributing to inconsistent shutoff conditions. These fluctuations can lead to varying amounts of material seepage, resulting in inconsistent and undesirable surface finishes on the parts.

To address these issues, the disclosed injection molding technology employs a different approach. Instead of relying on a shutoff, it uses interchangeable inserts with a protrusion that creates a controlled gap relative to the mold's sidewall. This design ensures that the material can flow around the protrusion without the need for the insert to touch the sidewall directly, thereby eliminating the primary cause of blemishes. By maintaining a precise gap, the technology prevents material seepage and ensures that the apertures are formed cleanly, without flashing or surface defects.

Another aspect of this technology is its versatility, achieved through the use of interchangeable inserts. Inserts with protrusions are used to create parts with apertures, while inserts without protrusions ensure a smooth mold surface for producing identical parts without openings. This capability to switch inserts easily allows manufacturers to use the same mold for producing identical parts with and without apertures, enhancing efficiency and reducing production costs.

Moreover, the technology incorporates several features to further improve the molding process. One such feature is the inclusion of vent apertures in the inserts, which extend through the protrusion. These vent apertures are configured to venting gases that accumulate between the sidewall of the second mold portion and the protrusion, preventing gas entrapment and ensuring a high-quality finish of the molded parts. Additionally, the system is equipped with sensors that measure the melt flow rate of the material. A controller, which includes a processor and memory, receives input from these sensors and can shut off the material source if the melt flow rate exceeds a predetermined threshold. This precise control over the melt flow rate is important to prevent flashing and maintain the integrity of the apertures.

To ensure the gap size between the protrusion and the sidewall is consistent and precise, the technology may also include optical sensors. These sensors measure the location of the protrusion and the sidewall when the mold is open, allowing the controller to infer and maintain the correct gap size. Furthermore, adjustable spacers positioned around the outer periphery of the mold can be adjusted to maintain the size of the gap, ensuring consistent and high-quality production of parts.

This injection molding technology represents a significant advancement in the field by solving a common problem of creating high-quality parts with and without apertures using the same mold. Its design ensures that parts with apertures are free from blemishes and flashing, while also allowing for the easy production of parts without apertures through interchangeable inserts. The incorporation of advanced features such as vent apertures, melt flow rate sensors, and optical sensors further enhances the precision and quality of the molding process, making this technology a valuable asset for manufacturers seeking to produce consistent and defect-free parts.

### EXAMPLE EMBODIMENTS

The present disclosure pertains to injection molding methods and resulting products made therefrom. In one embodiment, a tool/mold can be modified in such a way that a relief or offset is created between an insert and the product being molded. The result of this injection molding process is a resultant product that requires little, to no CNC routing to produce a final product. Also, another goal is to create a tool having inserts that will mold a product that has an aperture created by an insert with the relief or offset, as well as another insert that can be used to produce the same exact product but without an aperture. The second product can be made free from blemishes or artifacts because the insert used to create the product with the aperture does not create a shutoff inside the tool (e.g., the insert does not touch a tool surface in the process of creating the aperture).

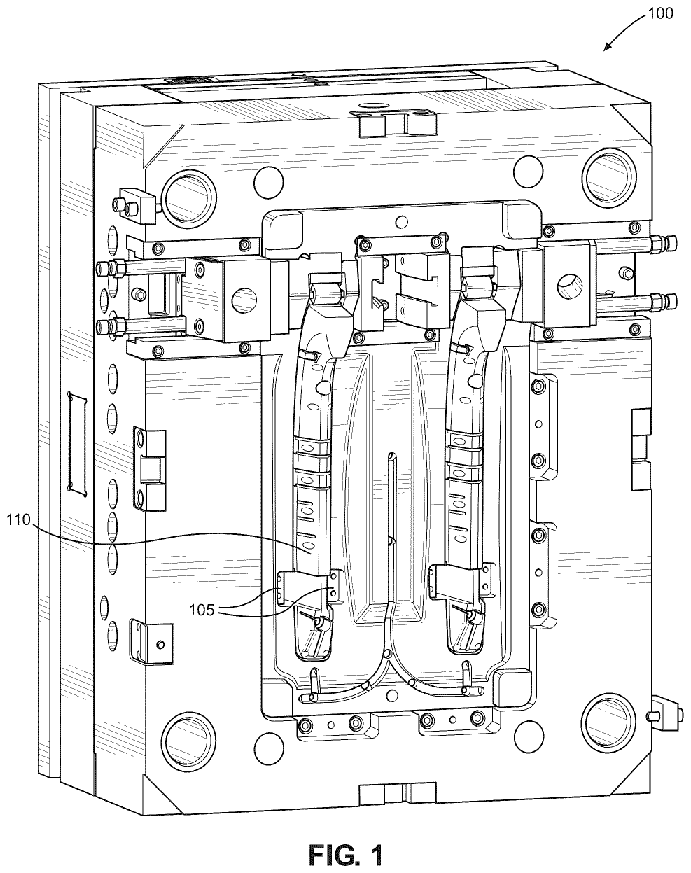

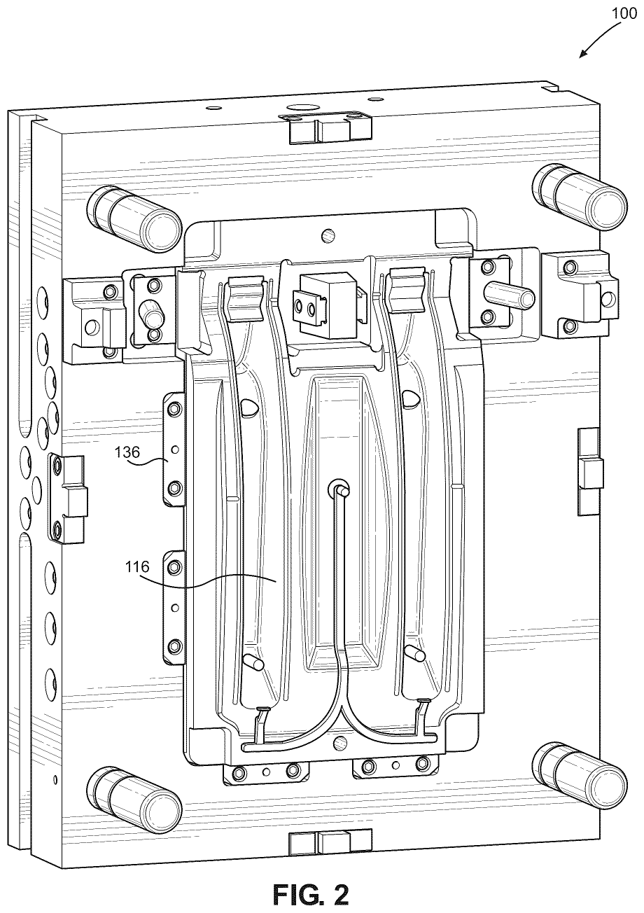

FIG. 1 is a perspective view of an example core 100 of an injection mold tool (hereinafter “tool”). The tool is comprised of both the core 100 of FIG. 1 and the cavity of FIG. 2. The core 100 of an injection molding tool is a component that forms the internal cavity shape of the molded part. The core 100 is typically made of a high-strength, heat-resistant material to withstand the pressures and temperatures involved in the molding process. The core works in conjunction with a cavity portion of the tool to shape a molten material into the desired form. It includes features such as cooling channels to control the temperature during molding, ensuring that the part solidifies uniformly and meets precise dimensional tolerances. The design of the core part determines the quality, accuracy, and consistency of the final molded product.

As illustrated in FIG. 2, a cavity 102 of tool is the complementary component to the core 100, and it forms the outer surface of the molded part. The cavity 102 is also made from durable, heat-resistant materials to endure the high pressures and temperatures of the injection molding process. The cavity 102 works together with the core 100 to create the mold cavity where a molten material is injected and shaped. It includes various features such as venting channels to allow trapped gases to escape, ensuring a smooth and defect-free surface on the final product. The cavity's 102 precise design and machining achieve the desired part geometry, surface finish, and structural integrity. Like the core 100 the cavity 102 may also incorporate cooling channels to maintain optimal temperature control throughout the molding cycle, promoting uniform solidification and minimizing defects.

Referring now to FIGS. 3A and 3B, an insert 104 can be included on the core 100 of the tool. The core 100 is responsible for forming the internal features of a molded part (see FIG. 5), including any apertures or openings. By placing the insert 104 on the core 100, the tool can be easily modified to either create parts with apertures (using an insert with a protrusion) or without apertures (using an insert without a protrusion). This placement allows for the necessary versatility and precision in producing identical parts with different internal features.

In some instances (as shown in FIG. 1), the insert 104 can be placed into a receiver slot 105 in the core 100 and secured with fasteners such as bolts. In this way, the insert 104 becomes an integral part of the core 100 that forms the outer surface of a resultant part.

The insert 104 includes a body 106 and a protrusion 108. The insert 104 can be manufactured as a monolithic part from a single piece of material, or the insert 104 can be constructed from more than one part. The body 106 of the insert 104 is configured to be placed into a receiver slot or hole in the core 100 so that a portion of the insert 104 forms a contiguous part of a sidewall 110 of the core 100 (again see FIG. 1), except for the protrusion 108 that extends beyond the sidewall 110.

In an injection molding system, the protrusion 108 on the insert 104 can include a vent 109 to address the issue of gas accumulation during the molding process. This vent 109 is placed within the protrusion 108 and extends through it, allowing trapped gases to escape from the gap between the sidewall of the mold cavity and the protrusion.

As molten material is injected into the mold cavity, air and other gases can become trapped in the narrow spaces (e.g., gap), particularly around the protrusion. If not properly vented, these trapped gases can cause defects in the molded part, such as voids, surface imperfections, or incomplete filling. The vent 109 in the protrusion 108 provides a pathway for these gases to escape, ensuring that the material fills the cavity uniformly and completely.

The vent 109 works by allowing the gases to flow out as the molten material pushes into the cavity, preventing pressure buildup and ensuring a smooth molding process. This venting mechanism is especially important when producing parts with apertures, as it helps maintain the integrity and quality of the aperture by preventing gas-related defects.

As best illustrated in FIG. 4A, when the core 100 and cavity 102 are closed, the protrusion 108 of the insert 104 creates a gap 112. The gap 112 is formed between an upper surface 114 of the protrusion 108 and a sidewall 116 of the cavity 102. The gap 112 has a size (thickness T) that can vary from between approximately 0.1 mm and 0.4 mm, inclusive. It will be understood that gaps of other sizes are contemplated.

A part 118 having an aperture 120 substantially or completely free from flashover is shown in FIG. 5. The production of the aperture 120 is also due, in part, to a melt flow rate of the plastic or material 117 used to product the part 118, as will be discussed in greater detail herein.

An alternate insert 122 is illustrated in FIG. 4B and in perspective new in FIG. 4C. This alternate insert 122 produces a second part 124 that is different from the part 118 produced using the insert 104 of FIGS. 3A and 3B (the exception that there is no protrusion in the second part 124). The second part 124 is identical to the first part 118 and has a textured outer surface but without the aperture, as shown in FIG. 6. The outer surface 125 of the second part 124 is free from blemishes or imperfections that would be present if the part 118 were to have been produced using an insert with a protrusion that created a shutoff area (i.e., point of contact between the protrusion and the sidewall of the cavity. To be sure, after repeated cycles, an insert having a protrusion that creates a shutoff area against the cavity would leave an indelible mark on the sidewall of the cavity. When the insert 104 is replaced with the alternate insert 122 to produce the second part 124, the second part 124 would have a blemish or imperfection due to the defect created in the sidewall 116 of the cavity 102.

Referring now to FIG. 7, which illustrates a schematic diagram of a system. The system includes an injection molding machine 126, a tool 10 (core 100 and cavity 102 in combination), a material source 128, and a controller 130. An injection molding machine 126 is designed to manufacture precise and high-quality plastic parts by injecting molten material into the tool 10. The machine comprises several key components, including the material source 128, an injection unit 129, and a clamping unit (not shown). The material source 128 heats and melts raw plastic granules or pellets, transforming them into a molten state. This melted material is then fed into the injection unit, where a screw or plunger mechanism pushes it forward under high pressure, ensuring a consistent and controlled flow into the tool 10. The material source can be located outside the injection molding machine 126 or can be integrated into the injection molding machine 126.

The clamping unit holds the tool 10 securely in place, ensuring that the tool 10 remains closed during the injection and cooling processes. The tool itself, consisting of core and cavity parts, shapes the final product. By using interchangeable inserts, the tool 10 can be adapted to produce various parts, including those with or without apertures, enhancing the machine's versatility and efficiency in manufacturing different designs. This setup allows for the creation of complex and intricate shapes with consistent accuracy and repeatability.

The controller 130 oversees and regulates the molding process. This controller 130 is equipped with a processor 131 and memory 133, enabling it to perform a variety of functions. The processor executes instructions and performs calculations necessary for controlling the various parameters of the molding process, such as temperature, pressure, and injection speed.

The memory within the controller stores these instructions, as well as data collected from sensors and other monitoring devices integrated into the machine. This data can include real-time information on the melt flow rate, temperature readings, and the position of the mold components. By processing this information, the controller 130 can make adjustments to maintain optimal operating conditions, ensuring consistent quality and efficiency.

In the injection molding process, managing the melt flow rate of the material is useful for producing high-quality parts. The melt flow rate refers to the speed at which the molten plastic flows into the mold cavity. Maintaining this rate within a specific range helps to prevent defects such as flashing, incomplete filling, or poor surface finish.

To achieve this, the injection molding machine is equipped with sensor(s) 132 that monitor the melt flow rate in real-time. These sensors provide continuous feedback to the controller, which has a processor and memory to process this data. The controller is programmed with a predefined melt flow rate threshold, representing the upper limit beyond which the quality of the molded parts could be compromised.

A sensor designed to monitor the melt flow rate in an injection molding machine could be located within the injection unit, close to where the molten material is being injected into the mold. Placing the sensor near the end of the injection barrel, where the molten material is about to be pushed into the mold cavity, allows for accurate monitoring of the flow rate just before it enters the mold. This placement ensures that the sensor can provide real-time data on the material's flow characteristics as it is being injected.

Another location for the sensor 132 is within a nozzle of the injection unit. The nozzle is the final point through which the molten material passes before entering the mold cavity. By situating the sensor in the nozzle, the controller 130 can detect any changes in the flow rate and respond promptly to maintain optimal conditions. This location also helps in monitoring the temperature and pressure of the molten material, which are also factors in controlling the flow rate.

Additionally, some systems may place sensors within the tool itself, particularly near the gate where the material first enters the tool. This allows for direct measurement of the flow rate as the material fills the cavity, providing precise control over the injection process. By using sensors in these strategic locations, the injection molding machine can ensure that the melt flow rate remains within the desired range, preventing defects such as flashing around apertures and ensuring the production of high-quality parts.

If the sensors detect that the melt flow rate is approaching or exceeding this threshold, the controller takes corrective actions. One such action might be to reduce the injection pressure or temporarily shut off the material source to bring the melt flow rate back within the acceptable range. For example, when creating parts with apertures, a flow rate that is too high can cause flashing around the protrusion. By managing the melt flow rate effectively, the controller ensures that the molten material fills the mold cavity uniformly and consistently, producing parts that meet the desired specifications and quality standards.

When the sensors detect that the melt flow rate is approaching or exceeding this threshold, the controller takes corrective actions. One such action might be to reduce the injection pressure or temporarily shut off the material source to bring the melt flow rate back within the acceptable range. By doing so, the controller ensures that the molten material fills the mold cavity uniformly and consistently, producing parts that meet the desired specifications and quality standards.

This precise control over the melt flow rate is particularly important when using interchangeable inserts in the mold. For example, when creating parts with apertures, the material must flow at a rate that prevents flashing around the protrusion of the insert. Similarly, when producing parts without apertures, the flow rate must ensure a smooth and uninterrupted mold surface. The controller's 130 ability to monitor and adjust the melt flow rate in real-time is a factor in achieving these outcomes and maintaining the efficiency and reliability of the injection molding process.

Ensuring the gap size remains consistent between molding cycles is important for maintaining the quality and precision of the produced parts. Variations in the gap size can lead to defects such as flashing, incomplete filling, or irregular surface finishes. By continuously monitoring and adjusting the gap size, the injection molding machine can produce parts with consistent dimensions and high-quality finishes.

In one embodiment, the system can include optical sensors 134, such as laser sensors, can be effectively used to measure or infer the gap between the core and cavity parts of a mold after it is opened. These sensors provide precise and non-contact measurement capabilities, which are ideal for assessing small distances and complex geometries within the mold.

When the mold opens after a cycle, the optical sensors 134 can be directed towards the areas of interest, such as the location of the protrusion on the insert and the corresponding sidewall on the other part of the mold. By emitting laser beams or light pulses and measuring the time it takes for the reflections to return, these sensors can accurately determine the distance between the surfaces. This method, often referred to as time-of-flight measurement, allows for high-resolution mapping of the gap.

LIDAR (Light Detection and Ranging) sensors, which use a similar principle but with multiple laser beams, can create a detailed 3D map of the mold's internal geometry. This data can be used to infer the size of the gap and identify any variations or misalignments that may affect the quality of the molded parts. By analyzing the data collected by the optical sensors 134, the controller 130 can make necessary adjustments to maintain the desired gap size, ensuring consistent and defect-free production.

The controller 130 receives real-time data from the optical sensors 134. It processes this information to monitor the gap size between the protrusion of insert and the sidewall of the cavity. If any deviations from the specified gap are detected, the controller 130 can adjust the molding parameters accordingly, such as adjustable spacers 136 shown in FIG. 2. This integration of optical sensing technology with the controller 130 enhances the precision and reliability of the injection molding process, leading to higher quality parts and reduced production defects.

In one embodiment, the controller 130 that can automatically adjust the spacers 136 placed around an outer-periphery of the mold cavity where the parts are made. These spacers 136 are strategically positioned to influence a size of the gap between the core and cavity parts of the tool 10.

During the molding process, the optical sensors 134 continuously monitor the gap size to detect any discrepancies. If the sensors identify variations from the desired gap size, this information is relayed to the controller 130. The controller 130 processes this real-time data and determines the necessary adjustments to maintain the specified gap.

The controller 130 then sends commands to actuators connected to the spacers 136. These actuators move the spacers in or out, depending on the detected discrepancies, to correct the gap size. By dynamically adjusting the spacers, the system ensures that the gap remains consistent throughout the molding cycles, thereby preventing defects such as flashing or incomplete filling.

The spacers around the outer periphery of the mold cavity can be moved using hydraulic actuators. These actuators use hydraulic fluid to generate movement, providing significant force and precise control over positioning. Hydraulic actuators are robust and well-suited for handling the high pressures involved in the injection molding process, ensuring reliable and consistent adjustments to maintain the desired gap size.

Another option for moving the spacers is pneumatic actuators, which use compressed air to create motion. Pneumatic actuators are known for their fast response times and ease of maintenance. They are suitable for applications where rapid and frequent adjustments are necessary. By using compressed air, pneumatic actuators can effectively move the spacers in and out, ensuring the gap size remains within the specified range throughout the molding cycles.

Electric actuators can also be used to move the spacers. These actuators convert electrical energy into mechanical motion, offering precise control and programmability. Electric actuators are ideal for applications that require fine adjustments and high accuracy. They can be easily integrated with the controller 130, allowing for automated adjustments based on real-time data from the optical sensors 134. This integration ensures that the gap size is consistently maintained, resulting in high-quality molded parts.

Piezoelectric actuators could be considered for moving the spacers. These actuators use piezoelectric materials that change shape when an electric voltage is applied. Piezoelectric actuators are capable of extremely precise movements and can operate at high speeds. They are suitable for applications requiring minute adjustments and high precision, ensuring that the gap size remains consistent and accurate throughout the molding process.

While some embodiments disclose controlled movement of the spacers, the spacers can also be adjusted manually by an operator. For instance, the spacers can be secured in place using threaded fasteners. The operator can adjust the placement of the spacers by screwing or unscrewing the associated fasteners, allowing for precise manual control over the gap size between the mold components. This manual adjustment provides flexibility in setting and fine-tuning the mold configuration to ensure consistent part quality. In some instances, spacers can be located in part on the core, and in part on the cavity.

Referring now to FIG. 8, which illustrates an example insert 140 that can incorporate an optical sensor 142. The insert 140 is identical to the insert 104 described above except that the protrusion 108 includes both the vent 109 and another port for the optical sensor 142. By incorporating the optical sensor 142 into the insert 140, a gap between the protrusion and the sidewall of the cavity that is created when the core and cavity are closed can be measured directly. The optical sensor 142 could be communicatively coupled to the controller 130 (see FIG. 7) via an electrical wire passed through a vent conduit 144. In other embodiments, the sensor 142 can communicate with the controller 130 over a short or long range wireless network.

### In Use Examples

The following paragraphs describe an example use case related to the operation of a system as disclosed herein. An operator begins by setting up the injection molding tool for production. This involves creating parts with and without apertures using the same mold. The operator starts by installing the first insert onto the first mold portion. This insert features a protrusion that will create an aperture in the molded part. The operator aligns the second mold portion to ensure proper cavity formation, which defines the shape of the part to be molded.

Next, the operator powers on the injection molding machine and accesses the controller interface. The controller, equipped with a processor and memory, is programmed to manage various aspects of the injection molding process. The operator inputs the predefined melt flow rate threshold into the controller to ensure the material's flow rate remains within acceptable limits.

With the machine set up, the operator initiates the injection process. Material is injected into the cavity, where the presence of the protrusion on the first insert forms a gap with the sidewall of the second mold portion. This gap results in the formation of an aperture in the molded part without creating a shutoff against another tool surface, ensuring the aperture is free of flashing. The controller continuously monitors the melt flow rate via a sensor and will automatically stop the material source if the flow rate exceeds the predefined threshold, ensuring the quality of the part.

Once the part with an aperture is formed and cooled, the operator opens the mold and removes the part. To produce a part without an aperture, the operator removes the first insert and installs the second insert, which lacks the protrusion. The mold is closed again, and material is injected into the cavity. Without the protrusion, the material fills the cavity entirely, producing a part without an aperture.

In a related method, the system could include an optical sensor to determine the positions of the protrusion and the sidewall of the second mold portion when the mold is open. The data collected from the optical sensor(s) allows the controller to calculate the size of the gap accurately. If the calculated gap size deviates from the desired specification, the controller signals the operator to adjust a plurality of adjustable spacers positioned around the outer periphery of the mold. These spacers are fine-tuned to maintain the correct gap size, ensuring consistent quality in the produced parts.

In another embodiment, if the gap size deviates from the desired specification, the controller automatically adjusts a plurality of adjustable spacers positioned around the outer periphery of the mold. These spacers are fine-tuned by the controller to maintain the correct gap size, ensuring consistent and high-quality production of the molded parts. The locations of the spacers can be controlled directly or indirectly by operation of actuators associated with the spacers, such as hydraulic pistons.

FIG. 9 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “mechanically connected,” etc., are used interchangeably herein to generally refer to the condition of being mechanically/physically connected. The terms “couple” and “coupling” are also used in a non-mechanical/physical context that refers to absorption of microwave energy by a material. It is further noted that various figures (including component diagrams) shown and discussed herein are for illustrative purpose only, and are not drawn to scale.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be necessarily limiting of the disclosure. As used herein, the singular forms “a,” “an”, and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three-dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. An injection molding tool that can be used to create both a first part with an aperture and a second part without an aperture, comprising:
a first portion;
a second portion;
a first insert installed on the first portion, the insert comprising a protrusion that creates a gap relative to a sidewall of the second portion when the first portion and the second portion are closed to form an injection molding tool; and
a material source that flows material into the injection molding tool, the material having a melt flow rate that is below a melt flow rate threshold to create a first part with an aperture due to presence of the protrusion and the gap, wherein the aperture has no flashing and the protrusion does not create a blemish in the sidewall of the second portion.

2. The injection molding tool according to claim 1, further comprising a second insert that can be installed in place of the first insert to produce a second part that is identical to the first part but having no aperture and including no blemish or imperfection due to the presence of the protrusion.

3. The injection molding tool according to claim 1, further comprising a vent aperture in the first insert and extending through the protrusion, for venting gas that accumulates between the sidewall of the second portion and the protrusion.

4. The injection molding tool according to claim 1, further comprising:
a sensor configured to measure the melt flow rate of the material; and
a controller that includes a processor and memory, the controller being configured to receive output from the sensor and shutoff the material source when the melt flow rate is above the melt flow rate threshold.

5. The injection molding tool according to claim 4, further comprising:
an optical sensor that is configured to measure a location of the protrusion and a location of the sidewall of the second portion when the injection molding tool is open; and
the controller being configured to infer a size of the gap based on output of the optical sensor.

6. The injection molding tool according to claim 1, further comprising a plurality of adjustable spacers positioned around an outer-periphery of the first part, the plurality of adjustable spacers are configured to be adjusted to maintain a size of the gap.

7. A method for producing a part with an aperture and a part without an aperture with a single mold, the method comprising:
providing a mold having a first portion, a second portion, and a first insert that can be installed on the first portion, the insert comprising a protrusion that does not create a shutoff relative to the second portion when the first portion and the second portion are closed to form the mold; and
flowing a material into the mold, the material having a melt flow rate that is below a melt flow rate threshold to create a part with an aperture due to presence of the protrusion, wherein the aperture has no flashing.

8. The method according to claim 7, further comprising:
opening the mold;
removing the first insert;
inserting a second insert; and
flowing a material into the mold to create a part without an aperture.

9. The method according to claim 8, further comprising venting through the first insert to prevent gas being trapped between the first insert and the second portion of the mold.

10. The method according to claim 9, further comprising:
placing one or more spacers around an outer-periphery of either the first portion or the second portion; and
adjusting the one or more spacers to maintain a size of a gap between the protrusion of the first insert and an adjacent tool surface of the second portion.

11. An injection molding tool comprising:
a first mold portion;
a second mold portion;
a first insert mounted on the first mold portion, the first insert having a protrusion that forms a gap with a sidewall of the second mold portion when the mold portions are closed; and
a second insert replaceable with the first insert, the second insert lacking the protrusion.

12. The injection molding tool according to claim 11, further comprising a material source designed to inject material into the mold, wherein the material has a melt flow rate below a predefined threshold, resulting in formation of a part with an aperture due to presence of the protrusion and the gap, where the aperture is free of flashing.

13. The injection molding tool according to claim 12, further comprising a vent aperture in the first insert and extending through the protrusion, for venting gas that accumulates between the sidewall of the second portion and the protrusion.

14. The injection molding tool according to claim 13, further comprising:
a sensor configured to measure the melt flow rate of the material; and
a controller that includes a processor and memory, the controller being configured to receive output from the sensor and shutoff the material source when the melt flow rate is above the melt flow rate threshold.

15. The injection molding tool according to claim 14, further comprising:
an optical sensor that is configured to measure a location of the protrusion and a location of the sidewall of the second portion when the injection molding tool is open; and
the controller being configured to infer a size of the gap based on output of the optical sensor.

16. The injection molding tool according to claim 15, further comprising a plurality of adjustable spacers positioned around an outer-periphery of a cavity that defines a first part created with the first insert, the plurality of adjustable spacers being a part of the first mold portion and configured to be adjusted to maintain a size of the gap.

17. A method for producing parts with an aperture and parts without an aperture using a single injection molding tool, comprising:
providing an injection molding tool having a first mold portion, a second mold portion, and a cavity defined between the first mold portion and the second mold portion when closed, the cavity defining a shape of a molded part;
installing a first insert on the first mold portion, the first insert having a protrusion that forms a gap with a sidewall of the second mold portion when the mold portions are closed, wherein the protrusion does not create a shutoff against the mold;
injecting material into the cavity, the material having a melt flow rate below a predefined threshold, thereby forming a part with an aperture due to presence of the protrusion and the gap, where the aperture is free of flashing;
opening the mold and removing the part with an aperture;
replacing the first insert with a second insert, the second insert lacking the protrusion;
injecting material into the cavity with the second insert installed, thereby forming a part without an aperture; and
opening the mold and removing the part without an aperture.

18. The method of claim 17, further comprising:
measuring the melt flow rate of the material using a sensor; and
wherein a controller comprising a processor and memory is configured to receive input from the sensor and to stop a material source or an injection molding machine when the melt flow rate exceeds the predefined threshold.

19. The method of claim 17, further comprising:
using an optical sensor to determine positions of the protrusion and the sidewall of the second mold portion relative to one another when the mold is open; and
wherein a controller comprising a processor and memory is configured to calculate a size of the gap based on output from the optical sensor.

20. The method of claim 19, further comprising:
adjusting a plurality of adjustable spacers positioned around an outer periphery of the first mold portion or the second mold portion; and
wherein the controller receives input related to the position of the adjustable spacers and to maintain the gap size by controlling the adjustment of the spacers based on the received input.
